(19) United States
(12) Patent Application Publication
(10) Pub. No.: US 2008/0266855 A1
(43) Pub. Date: Oct. 30, 2008

(54) LIGHT EMITTING DEVICE AND LIGHT EMITTING DEVICE ASSEMBLY

(75) Inventor: Katsuyuki OKIMURA, Tokyo (JP)

Correspondence Address: YOUNG & THOMPSON, 209 Madison Street, Suite 500, ALEXANDRIA, VA, 22314, US

(73) Assignee: NEC LIGHTING, LTD., TOKYO (JP)

(21) Appl. No.: 12/109,372

(22) Filed: Apr. 25, 2008

(30) Foreign Application Priority Data
Apr. 27, 2007 (JP) 2007-116643

(51) Int. Cl. F21V 7/04; F21V 7/00

(52) U.S. Cl. 362/247; 362/297

(57) ABSTRACT

A light emitting device (1) includes a light emitting element (2), a substrate (3), a reflecting plate (4), and a screw member (5). The light emitting element is mounted in the substrate. The reflecting plate is arranged on the substrate. The screw member fixes the reflecting plate and the substrate to each other. The substrate includes a first surface (7), a second surface (8) on an opposite side of the first surface, and an applied part (11) on which the light emitting element is mounted. The reflecting plate includes a third surface (9) that comes into contact with the first surface, a fourth surface (10) on an opposite side of the third surface, and an opening portion (6). The opening portion penetrates the reflecting plate and opens on the third surface and the fourth surface. The opening portion has the shape such that an opening space on a side of the third surface of the reflecting plate is smaller than an opening space on a side of the fourth surface of the reflecting plate. The screw member penetrates the first surface of the substrate and the third surface of the reflecting plate from the second surface of the substrate towards an area in which the opening portion of the reflecting plate is not formed and to which the opening portion is near, whereby the screw member fixes the substrate and the reflecting plate to each other.

### BACKGROUND OF THE INVENTION

1. Field of the Invention

The present invention relates to a light emitting device and a light emitting device assembly, and in particular, to a light emitting device and a light emitting device assembly which are used for backlights for a liquid crystal display apparatus or used for light sources for an image reading apparatus such as an image scanner or a copier.

2. Description of the Related Art

As shown in FIG. 1, light emitting device 101 that includes light emitting diode 102 for an illumination light source is disclosed (refer to JP-A-2003-45206). Light emitting device 101 is constituted by mounting light emitting element 102 in substrate 103 and placing reflecting plate 104 on substrate 103. As a method of fixing substrate 103 and reflecting plate 104 to each other, a method of fixing by coating of an adhesive between a surface of substrate 103 and a surface of reflecting plate 104, or by “bonding” such as sticking a double sided tape on these surfaces is known. However, in the case where this bonding method was selected, there was the following problem: the adhesive overflowed from a joint portion between substrate 103 and reflecting plate 104, whereby light emitting element 102 mounted in substrate 103 was stained. Moreover, reflecting plate 104 peeled off from substrate 103 by deterioration of the adhesive. Thus, there was the following problem: light was emitted by light emitting element 102 and passed through a gap portion between the surface of substrate 103 and the surface of reflecting plate 104, with the gap portion being generated during the peeling off in this peeling. The light was dissipated towards the outside of light emitting device 101, so that optical power performance of light emitting device 101 decreased.

In order to solve such problems, as shown in FIG. 2, a method of fixing reflecting plate 114 and substrate 113 to each other towards substrate 113 from reflecting plate 114 by using screws is proposed. In light emitting device 111 constituted by using this fixing method with the screws, adhesion between the surface of substrate 113 and the surface of reflecting plate 114 increases in comparison with the method of fixing substrate 113 and reflecting plate 114 by means of bonding. Accordingly, the problem of staining light emitting element 102 caused by the bonding method mentioned above and the problem that reflecting plate 104 peels off from substrate 103 are solvable by the method of fixing reflecting plate 114 and substrate 113 to each other towards substrate 113 from reflecting plate 114 using by the screws.

### SUMMARY OF THE INVENTION

In the case of the method of fixing reflecting plate 114 and substrate 113 to each other towards substrate 113 from reflecting plate 114 using by the screws, it is necessary to arrange a hole for screw member 115 in reflecting plate 114 in a position where a thread part and a head of screw member 115 do not make contact with opening portion 116 of reflecting plate 114. However, in the case of this method, when it is intended to arrange the hole for screw member 115 in reflecting plate 114 so that an edge portion of screw member 115 does not make contact with an edge portion of opening portion 116, it is necessary to place a comparatively large distance between a center of the hole for screw member 115 and a center of opening portion 116. Therefore, a space needed for both screw member 115 and the hole for screw member 115 in reflecting plate 114 increases, whereby it leads to increasing the size of reflecting plate 114. Accompanied with the increased size of reflecting plate 114, substrate 113 on which reflecting plate 114 is placed is also enlarged. After all, there is a problem that the entire light emitting device 111 is enlarged.

The present invention is made in view of the above-mentioned situation, and an object of the present invention is to provide a light emitting device and a light emitting device assembly which can achieve miniaturization of a substrate and a reflecting plate.

The first aspect of the present invention provides a light emitting device comprising: at least one light emitting element; a substrate that includes: a first surface located in a direction in which at least one light emitting element emits light; a second surface located on an opposite side of the first surface; and at least one applied part on which at least one light emitting element is mounted; a reflecting plate that is arranged on the substrate, the reflecting plate including: a third surface that comes into contact with the first surface of the substrate; a fourth surface located on an opposite side of the third surface; and at least one opening portion that penetrates the reflecting plate and that opens on the third surface and the fourth surface; and at least one screw member that fixes the reflecting plate and the substrate, wherein at least one opening portion is arranged in the reflecting plate so as to coincide with a position in which at least one light emitting element is mounted on at least one applied part of the substrate, and a shape of at least one opening portion is such that an opening portion space on a side of the third surface of the reflecting plate is smaller than an opening portion space on a side of the fourth surface of the reflecting plate, and wherein at least one screw member penetrates the first surface of the substrate and the third surface of the reflecting plate from the second surface of the substrate towards an area in which at least one opening portion of the reflecting plate is not formed and to which at least one opening portion is near, whereby at least one screw member fixes the substrate and the reflecting plate to each other.

The second aspect of the present invention provides a light emitting device assembly comprising a plurality of the above described light emitting devices, wherein each of the plurality of the light emitting devices includes two or more of at least one light emitting element, and the plurality of the light emitting devices are coupled with each other so that at least one light emitting element of each of the plurality of the light emitting devices is mutually arranged in a line at equal distances.

The shape of the opening portion is such that the opening portion space on the side of the third surface of the reflecting plate is smaller than the opening portion space on the side of the fourth surface of the reflecting plate. Therefore, when the substrate and reflecting plate are in a state in which they are fixed to each other by a screw member, the screw member and the opening portion of the reflecting plate are closely arranged without the screw member and the opening portion of the reflecting plate being in contact with each other. Accordingly, since a hole for a screw member can be provided near the opening of the reflecting plate, miniaturization of the reflecting plate can be achieved, and miniaturization of the substrate can be also achieved accompanied with the miniaturization of the reflecting plate.

### BRIEF DESCRIPTION OF THE DRAWINGS

FIG. 1 is a perspective view showing one form of a conventional fluorescent lamp;

FIG. 2 is a perspective view showing another form of a conventional fluorescent lamp;

FIG. 3A is a top view showing a light emitting device in which a plurality of other forms of the conventional fluorescent lamp are provided and arranged side by side in a line;

FIG. 3B is a graph showing the distribution of the optical power of light which the light emitting device of FIG. 3A emits;

FIG. 4 is a perspective view showing a light emitting device according to a first exemplary embodiment of the present invention;

FIG. 5 is a sectional view which is taken on line II-II of the light emitting device in FIG. 4 and shows a fixation structure between a substrate and a reflecting plate;

FIG. 6 is a bottom view of the light emitting device in FIG. 4 which shows a positional relation between each of screw members and each of opening portions;

FIG. 7A is a top view showing a light emitting device in which a plurality of light emitting devices according to the first exemplary embodiment of the present invention are provided and arranged side by side in a line; and

FIG. 7B is a graph showing the distribution of the optical power of light which the light emitting device of FIG. 7A emits.

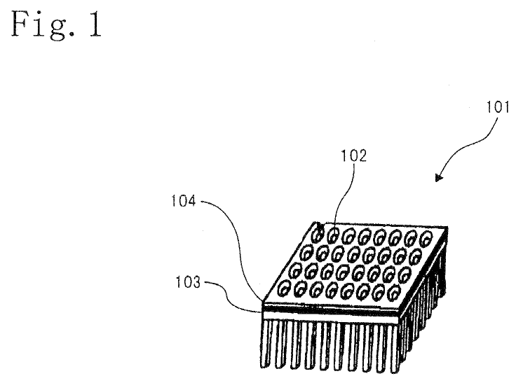

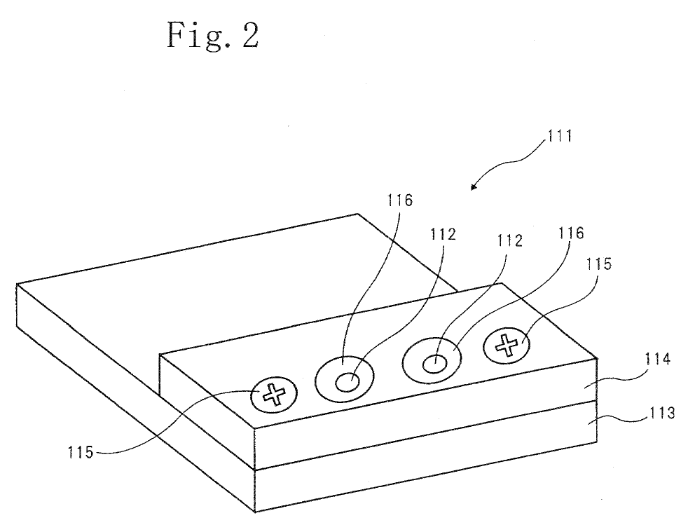

### DETAILED DESCRIPTION OF EXEMPLARY EMBODIMENTS

Hereinafter, exemplary embodiments of a light emitting device and a light emitting device assembly of the present invention will be described in detail with reference to drawings.

### First Exemplary Embodiment

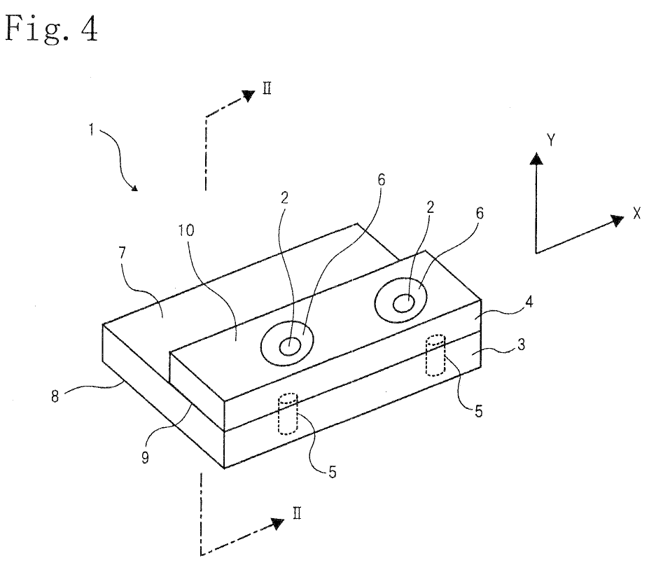

FIG. 4 is a perspective view showing a light emitting device according to a first exemplary embodiment of the present invention. A Y direction shown in FIG. 4 is a direction in which reflecting plate 4 is placed on substrate 3 with third surface 9 of reflecting plate 4 coming into contact with first surface 7 of substrate 3. An X direction is a direction which is orthogonal to the Y direction, and in which an applied part of substrate 3 extends.

Light emitting device 1 includes at least one light emitting element 2, substrate 3, reflecting plate 4, and at least one screw member 5. Light emitting element 2 is mounted in substrate 3. Reflecting plate 4 is arranged on substrate 3. Screw member 5 fixes reflecting plate 4 and substrate 3 to each other.

Light emitting element 2 is connected to an anode and a cathode which are not shown. Also, light emitting elements 2 may be electrically connected to each other. Further, it is desirable that light emitting element 2 is a light emitting diode.

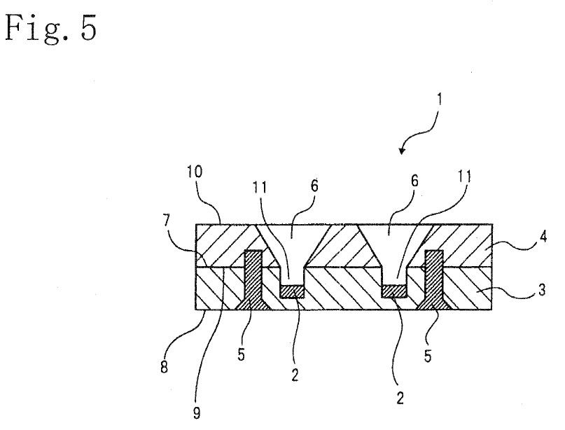

Substrate 3 includes first surface 7, second surface 8, and at least one applied part 11. First surface 7 is located in a direction in which light emitting element 2 emits light. Second surface 8 is located on an opposite side of first surface 7. At least one light emitting element 2 is mounted in applied part 11 (refer to FIG. 5). First surface 7 is parallel to second surface 8, and each of the side surfaces of substrate 3 is provided so as to be orthogonal to first surface 7 and second surface 8. Because of these upper and lower faces and each of the side surfaces which constitute the surfaces of substrate 3, substrate 3 has the shape of a flat plate. One light emitting element 2 is arranged in each applied part 11. Also, applied part 11 may be provided in substrate 3 so as to extend in a groove. In addition, although applied part 11 is provided having a concave shape in substrate 3 in drawings showing exemplary embodiments of the present invention, it is not limited to this form. Namely, applied part 11 may be arranged on first surface 7 of substrate 3.

Reflecting plate 4 includes third surface 9, fourth surface 10, and at least one opening portion 6. Third surface 9 comes into contact with first surface 7 of substrate 3. Fourth surface 10 is located on an opposite side of third surface 9. Opening portion 6 penetrates reflecting plate 4 and opens on third surface 9 and fourth surface 10. Third surface 9 is parallel to fourth surface 10, and each of the side surfaces of reflecting plate 4 is provided so as to be orthogonal to third surface 9 and fourth surface 10. Because of these upper and lower faces and each of the side surfaces which constitute the surfaces of reflecting plate 4, reflecting plate 4 has the shape of a flat plate.

Opening portion 6 of reflecting plate 4 is arranged in reflecting plate 4 so as to coincide with a position in which light emitting element 2 is mounted in applied part 11 of substrate 3. Furthermore, the shape of opening portion 6 is such that an opening portion space on a side of third surface 9 of reflecting plate 4 is smaller than an opening portion space on a side of fourth surface 10 of reflecting plate 4 (refer to FIG. 5). A square, a rectangle, a circle or an ellipse can be adopted as a planar shape of opening portion 6. Also, an edge portion including a wall surface by which opening portion 6 is defined can be constituted by forming a base portion (not shown), a reflective layer (not shown), and a diffusion layer (not shown). The reflective layer is arranged on the base portion and reflects light which is emitted by light emitting element 2. The diffusion layer is arranged on the reflective layer and diffuses light which has been reflected by the reflective layer to a wide region due to refraction action, diffraction action and diffusion action. It is preferable to include a thermoplastic resin such as a polyethylene terephthalate (PET) resin, as for a material for the base portion. It is preferable to include Al, Ag, Zn, Ni or the like, as for a material for the reflective layer. It is preferable to include titanium oxide (TiO₂), silicon oxide (SiO₂), zirconium oxide (ZrO₂) or the like, as for a material for the diffusion layer. Moreover, physical vapor deposition such as a vacuum deposition method or a sputtering method is used, as a film formation method for coating the reflective layer on the base portion and as a film formation method for coating the diffusion layer on the reflective layer.

Screw member 5 penetrates first surface 7 of substrate 3 and third surface 9 of reflecting plate 4 from second surface 8 of substrate 3 towards an area in which opening portion 6 of reflecting plate 4 is not formed and to which opening portion 6 is near. Substrate 3 and reflecting plate 4 are fixed by this screw member 5. Also, when substrate 3 and reflecting plate 4 are in a state in which they are fixed to each other by screw member 5, it is desirable that an end portion of screw member 5 does not reach fourth surface 10 of reflecting plate 4. Further, it is desirable that a hole which not only penetrates first surface 7 of substrate 3 from second surface 8 of substrate 3, but which also penetrates third surface 9 of reflecting plate 4 reaches fourth surface 10 of reflecting plate 4. It is desirable that screw member 5 includes a pan head or a flat head whose upper surface (first end portion) is flat. Furthermore, it is desirable that screw member 5 is a parallel screw whose thread part's diameter is constant, or a cone screw which tapers from one end portion of a thread portion near the head toward another end portion (second end portion) of the thread portion far from the head.

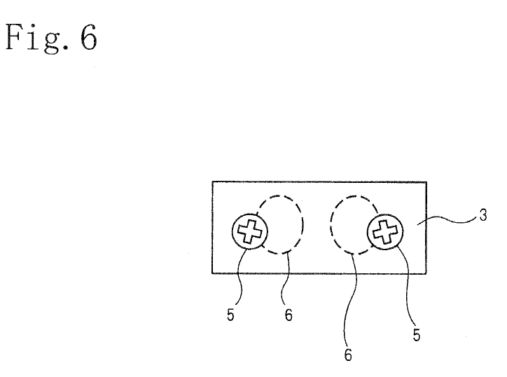

Next, with reference to FIG. 5, a method of fixing substrate 3 and reflecting plate 4 of light emitting device 1 to each other will be described. First, each light emitting element 2 is mounted on each applied part 11 of substrate 3. Secondly, reflecting plate 4 is placed on substrate 3 so that a position of each light emitting element 2 in substrate 3 coincides with a position of each opening portion 6 in reflecting plate 4. Thirdly, after a second end portion of screw member 5 penetrates substrate 3 toward first surface 7 from second surface 8 of substrate 3, the second end portion of screw member 5 passes third surface 9 of reflecting plate 4. After that, with the second end portion of screw member 5 advancing into an area in which opening portion 6 of reflecting plate 4 is not formed, an upper surface of a first end portion of screw member 5 approaches first surface 7 of substrate 3. Finally, the upper surface of the first end portion of screw member 5 coincides with first surface 7 of substrate 3, and when these upper surface and first surface 7 form one plane, fixation between substrate 3 and reflecting plate 4 is completed. Meanwhile, the shape of opening portion 6 of reflecting plate 4 is such that the opening portion space on the side of third surface 9 is smaller than the opening portion space on the side of fourth surface 10 as mentioned above. Therefore, when substrate 3 and reflecting plate 4 are in a state in which they are fixed to each other by screw member 5, screw member 5 and opening portion 6 of reflecting plate 4 are closely arranged without making contact with each other. At this time, as shown in FIG. 6, the distance between a center of screw member 5 and a center of opening portion 6 of reflecting plate 4 becomes smaller than the conventional distance between a center of screw member 5 and a center of opening portion 6 of reflecting plate 4.

Accordingly, since a hole for each screw member 5 can be provided near each opening portion 6 of reflecting plate 4, miniaturization of reflecting plate 4 can be achieved. Thus, miniaturization of substrate 3 can be also achieved accompanied with the miniaturization of reflecting plate 4.

### Second Exemplary Embodiment

A light emitting device assembly can be made by combining a plurality of light emitting devices described above. This light emitting device assembly can be used for an image reading apparatus such as an image scanner or a copier. Before explaining an exemplary embodiment of the light emitting device assembly, a conventional light emitting device assembly will be explained first.

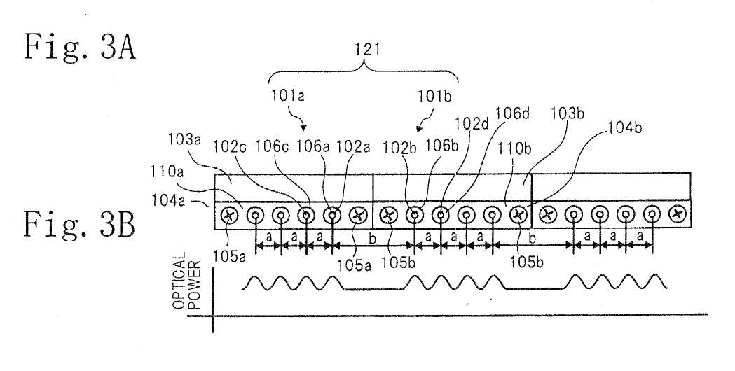

As shown in FIG. 3A, conventional light emitting device assembly 121 includes a plurality of light emitting devices 101a, 101b. Light emitting devices 101a, 101b are arranged in a line so that light emitting elements 102a, 102b, 102c, 102d are located in a line. Moreover, light emitting devices 101a, 101b are formed by a method of fixing reflecting plates 104a, 104b and substrates 103a, 103b to each other with screws 105a, 105b towards substrates 103a, 103b from fourth surface 110a, 110b of reflecting plates 104a, 104b. In this exemplary embodiment, it is necessary to provide holes for screw members 105a, 105b on a side of fourth surfaces 110a, 110b of reflecting plates 104a, 104b between opening portions 106a in an endmost portion of reflecting plate 104a, and opening portions 106b in an endmost portion of another reflecting plate 104b adjacent to reflecting plate 104a. Thus, an interval b between a center of opening portion 106a and a center of opening portion 106b becomes larger than each of intervals between each of centers of opening portions 106a, 106b, 106c, 106d in reflecting plates 104a, 104b. Also, light emitting element 102a is arranged in substrate 103a so that a position of light emitting element 102a in substrate 103a coincides with a position of opening portion 106a in reflecting plate 104a. Meanwhile, light emitting element 102b is arranged in substrate 103b so that a position of light emitting element 102b in substrate 103b coincides with a position of opening portion 106b in reflecting plate 104b. Together with the enlargement of the center interval between opening portions 106a, 106b, the interval between each peak position of the optical power of light emitting element 102a and that of the optical power of light emitting element 102b becomes larger than each interval between each of peak positions of the optical power of light emitting elements 102a, 102b, 102c, 102d in light emitting device 101a, 101b. As a result, as shown in FIG. 3B, irregularity of the distribution of the optical power of light, which light emitting elements 102a, 102b, 102c, 102d of light emitting device assembly 121 emit, is generated. Therefore, when this light emitting device assembly 121 is used as a light source for an image reading apparatus, nonuniform illuminance arises on an image which the light source illuminates, so that brightness and darkness are generated on the image. Accordingly, the problem occurs in which the image reading performance of an apparatus for recognizing and reading images decreases.

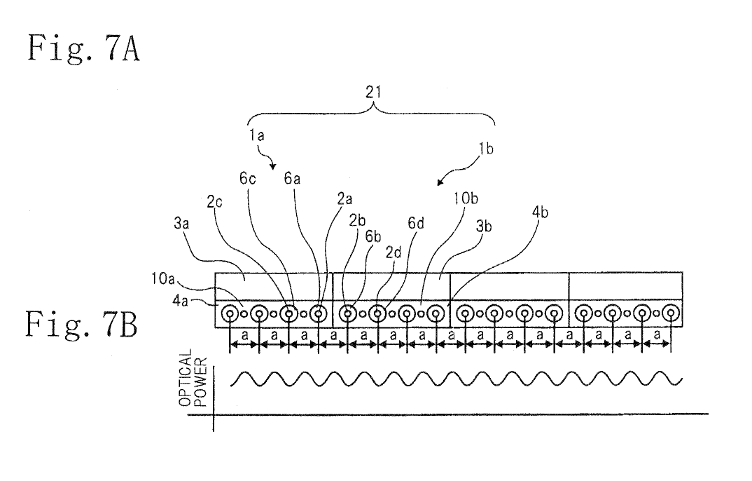

Meanwhile, as shown in FIG. 7A, light emitting device assembly 21 according to a second exemplary embodiment of the present invention includes a plurality of light emitting devices 1a, 1b of the first exemplary embodiment. Light emitting devices 1a, 1b include at least two light emitting elements 2a, 2b, 2c, 2d. Further, light emitting devices 1a, 1b are coupled with each other so that light emitting element 2a, 2b, 2c, 2d of light emitting devices 1a, 1b are mutually arranged in a line at equal distances.

In this light emitting device assembly 21, substrates 3a, 3b and reflecting plates 4a, 4b are fixed to each other with screws from second surfaces 8 of substrates 3a, 3b towards an area in which opening portions 6a, 6b of reflecting plates 4a, 4b are not formed. Therefore, it is not necessary to provide holes for screw members 5 between opening portions 6a, which are arranged in an endmost portion of reflecting plate 4a, and opening portions 6b, which are arranged in an endmost portion of reflecting plate 4b on a side of fourth surfaces 10a, 10b of reflecting plates 4a, 4b. Thus, the intervals between each of light emitting elements 2a, 2b, 2c, 2d become equal. Consequently, as shown in FIG. 7B, the distribution of the optical power of light emitting element 2a, 2b, 2c, 2d of light emitting device assembly 21 becomes regular. Accordingly, in the case where this light emitting device assembly 21 is used as a light source for an image reading apparatus, uniformity of illuminance on the image which the light source illuminates increases in comparison with the conventional light emitting device assembly, whereby no brightness and darkness arises on the image. Therefore, it is possible to improve the image reading performance of an apparatus for recognizing and reading an image.

In addition, in the present exemplary embodiment, it is possible to create a linear light source because light emitting device assembly 21, which has a plurality of light emitting devices 1a, 1b in a line, is provided. Therefore, light emitting device assembly 21 can be used as a light source for a lighting equipment, or as a backlight for a liquid crystal display apparatus.

This application is based upon and claims the benefit of priority from Japanese Patent Application No. 2007-116643, filed on Apr. 26, 2007, the disclosure of which is expressly incorporated herein in its entirety by reference.

While exemplary embodiments of the present invention have been described using specific terms, such description is for illustrative purposes. It is to be understood that the invention is not limited to exemplary embodiments or constitutions. To the contrary, the invention is intended to cover various modifications and equivalent arrangements. In addition, while the various elements of exemplary embodiments are shown in various combinations and configurations, which are exemplary, other combinations and configurations, including more, less or only a single element, are also within the spirit and scope of the invention as defined in the following claims.

What is claimed is:

1. A light emitting device comprising:
at least one light emitting element;
a substrate that includes: a first surface located in a direction in which said at least one light emitting element emits light; a second surface located on an opposite side of the first surface; and at least one applied part on which said at least one light emitting element is mounted;
a reflecting plate that is arranged on the substrate, the reflecting plate including: a third surface that comes into contact with the first surface of the substrate; a fourth surface located on an opposite side of the third surface; and at least one opening portion that penetrates the reflecting plate and that opens on the third surface and the fourth surface; and
at least one screw member that fixes the reflecting plate and the substrate to each other,
wherein said at least one opening portion is arranged in the reflecting plate so as to coincide with a position in which said at least one light emitting element is mounted in said at least one applied part of the substrate, and a shape of said at least one opening portion is such that an opening space on a side of the third surface of the reflecting plate is smaller than an opening space on a side of the fourth surface of the reflecting plate, and
wherein said at least one screw member penetrates the first surface of the substrate and the third surface of the reflecting plate from the second surface of the substrate towards an area in which said at least one opening portion of the reflecting plate is not formed and to which said at least one opening portion is near, whereby said at least one screw member fixes the substrate and the reflecting plate to each other.

2. The light emitting device according to claim 1, wherein said at least one light emitting element is a light emitting diode.

3. The light emitting device according to claim 1, wherein a planar shape of said at least one opening portion of the reflecting plate is a square, a rectangle, a circle or an ellipse.

4. The light emitting device according to claim 1, wherein a hole into which said at least one screw member is inserted reaches the fourth surface of the reflecting plate.

5. The light emitting device according to claim 1, wherein said at least one screw member includes a pan head or a flat head.

6. The light emitting device according to claim 1, wherein said at least one screw member is a parallel screw or a cone screw.

7. A light emitting device assembly comprising a plurality of the light emitting devices according to claim 1,
wherein each of the plurality of the light emitting devices includes two or more of said at least one light emitting element, and
the plurality of the light emitting devices are coupled with each other so that said at least one light emitting element of each of the plurality of the light emitting devices is mutually arranged in a line at equal distances.

8. A lighting equipment comprising the light emitting device assembly according to claim 7.

9. A backlight comprising the light emitting device assembly according to claim 7.
